(19) United States
(12) Patent Application Publication
(10) Pub. No.: US 2005/0056319 A1
(43) Pub. Date: Mar. 17, 2005

(54) Regulator for fuel cell systems

(75) Inventors: Masakazu Hasegawa, Obu (JP); Shigehito Suzuki, Obu (JP)

Correspondence Address: STEVENS DAVIS MILLER & MOSHER, LLP, 1615 L STREET, NW, SUITE 850, WASHINGTON, DC, 20036, US

(73) Assignee: AISAN KOGYO KABUSHIKI KAISHA, Aichi-ken (JP)

(21) Appl. No.: 10/937,477

(22) Filed: Sep. 10, 2004

(30) Foreign Application Priority Data
Sep. 12, 2003 (JP) 2003-320976

(51) Int. Cl. G05D 16/06

(52) U.S. Cl. 137/505.42

(57) ABSTRACT

To enable a regulator for fuel cell systems having a first diaphragm on the back pressure chamber side and a second diaphragm on the pressure regulating chamber side, wherein the pressure in the pressure regulating chamber is regulated with the back pressure in the back pressure chamber, to regulate the pressure with a pressure differing from the pressure in the back pressure chamber, the pressure in the pressure regulating chamber is regulated by actuating the pressure regulating valve with the shifting of the two diaphragms depending on the relationship between the two pressures, wherein the effective area of the first diaphragm and the effective area of the second diaphragm are differentiated.

### BACKGROUND OF THE INVENTION

1. Field of the Invention

The present invention relates to a regulator for fuel cell systems, and more particularly to a regulator for regulating the pressure of fuel gas supplied to fuel cells in a fuel cell system comprising fuel cells which, supplied with fuel gas and oxidizer gas, generate electricity.

2. Description of the Related Art

Known regulators for use in fuel cell systems as mentioned above include one having a structure shown in FIG. 3 (see for instance JP-A-2003-68334). This conventional regulator will be described below.

In a body 101, two pressure regulating diaphragms 102 and 103 are arranged opposite each other with a space 104 provided between them, a space above one pressure regulating diaphragm 102 is formed into a back pressure chamber 105, and a space underneath the other pressure regulating diaphragm 103 is formed into a hydrogen gas passage 106 (pressure regulating chamber).

The back pressure chamber 105 is provided with an air inlet 107, and air pressurized by a compressor (not shown) is let into the back pressure chamber 105 through the air inlet 107. The hydrogen gas passage 106 is provided in its intermediate part with a valve seat 108, and a hydrogen gas passage 109 farther upstream than the valve seat 108 is supplied via a hydrogen gas inlet 110 with hydrogen gas discharged from a high pressure hydrogen tank (not shown). Further, a hydrogen gas passage 111 farther downstream from the valve seat 108 supplies hydrogen gas via a hydrogen gas outlet 112 to fuel cells (not shown).

An effective area (pressure receiving area) in which the back pressure (air pressure) works on the diaphragm 102 and an effective area (pressure receiving area) in which hydrogen gas pressure works on the other diaphragm 103 are set to be equal. In other words, the two diaphragms 102 and 103 and formed to have equal diameters.

Further, the two diaphragms 102 and 103 are linked by a stem 113 to be interlocked, and the tip of the stem 113 protruding into the hydrogen gas passage 109 is provided with a valve body 114 which alternately comes into or goes out of contact with the valve seat 108. In the drawing, reference numeral 115 denotes a spring.

In the structure described above, a first thrust attributable to the increased air pressure and the pressure of the spring work on the top face of the pressure regulating diaphragm 102, while a second thrust attributable to the increased pressure of hydrogen gas works on the under face of the other pressure regulating diaphragm 103, and the differential pressure of these two thrusts brings the valve body 114 into or out of contact with the valve seat 108. Thus, when the pressure in the hydrogen gas passage 106 becomes lower than the air pressure supplied into the back pressure chamber 105, the valve body 114 opens, and when the pressure in the hydrogen gas passage 106 becomes equal to the air pressure supplied into the back pressure chamber 105, the valve body 114 closes, to control the pressure within the hydrogen gas passage 106 to a prescribed level.

Then, as the effective areas of the two diaphragms 102 and 103 are set to be equal, the pressure of hydrogen gas in the hydrogen gas passage 106 is controlled equally to the pressure of air supplied to the back pressure chamber 105. Thus, the regulated pressure of hydrogen gas becomes equal to the air pressure as indicated by characteristic B in FIG. 4.

Incidentally, when high pressure hydrogen gas is to be supplied, after being regulated in pressure by a regulator such as the one described above, to fuel cells in a fuel cell system via piping, some item which could entail pressure loss, such as a shut-off valve, may be arranged on the piping between the regulator and the fuel cells. In such a case, to allow for that pressure loss, the pressure to which the hydrogen gas is to be regulated in the regulator part should be set higher than otherwise.

However, when the air pressure to be applied to the back pressure chamber 105 in the conventional structure described above can be supplied at only a limited low level under the constraint of the capacity of the compressor to generate this air pressure or for any other reason, the pressure of the hydrogen gas can be regulated only to an equal level to the air pressure. Therefore, it is impossible to supply the hydrogen gas regulated to a higher pressure than the air pressure to allow for the possible pressure loss and accordingly to secure the hydrogen gas pressure required by the fuel cells, involving the risk of inviting a performance deterioration of the fuel cells.

Or, where the space 104 defined by the diaphragms 102 and 103 as described above is made a sealed space, the air in the space 104, affected by an ambient condition such as the ambient temperature, repeats alternate thermal expansion and thermal contraction. This would affect the load transmitted between the back pressure chamber 105 and the hydrogen gas passage (pressure regulating chamber) 106, making it impossible to secure stabilized pressure regulation.

Furthermore, in the event that the diaphragms 102 and 103 are damaged, if the space 104 is in a sealed state, hydrogen and pressurized air may be combined in the regulator to invite a reaction of combustion.

### BRIEF SUMMARY OF THE INVENTION

The present invention is intended to solve the problems noted above, and to provide a regulator for fuel cell systems which can be smaller and less expensive than a regulator of any conventional structure.

In order to solve the problems noted above, according to a first aspect of the invention, there is provided a regulator for fuel cell systems having a first diaphragm on which a pressure from a back pressure chamber side works and a second diaphragm on which a pressure from a pressure regulating chamber side works, wherein a pressure regulating valve is actuated by the shifting of the two diaphragms depending on the relationship between the two pressures, and the effective area of the first diaphragm and the effective area of the second diaphragm are differentiated.

In the first aspect of the invention described above, the effective area of the second diaphragm can be set smaller than the effective area of the first diaphragm.

In the first aspect of the invention, the effective area of the first diaphragm can as well be set smaller than the effective area of the second diaphragm.

Further in the foregoing, pressurized air can be supplied to the back pressure chamber and pressurized hydrogen gas, to the pressure regulating chamber via the pressure regulating valve.

Further in the foregoing, an atmosphere chamber can be disposed between the first diaphragm and second diaphragm, and the atmosphere chamber can be open to the atmosphere.

Further in the foregoing, a hydrogen gas detector may be disposed on the flow path of atmosphere from the atmosphere chamber.

According to a second aspect of the invention, there is provided a regulator for fuel cell systems having a back pressure chamber to which pressurized air is supplied, a first diaphragm which receives a pressure from the back pressure chamber, a passage for supplying pressurized hydrogen gas to a pressure regulating chamber, a pressure regulating valve disposed on the passage, a second diaphragm which receives a pressure from the pressure regulating chamber, an atmosphere chamber disposed between the second diaphragm and the first diaphragm, and a coupling shaft which couples the two diaphragms and connects them to the pressure regulating valve, wherein the effective area of the second diaphragm is set smaller than the effective area of the first diaphragm, and pressure regulation is accomplished by opening and closing the pressure regulating valve at a higher pressure than the air pressure of the back pressure chamber.

In the second aspect of the invention described above, the configuration may as well be such that the pressure regulating valve, in which a valve part is formed on the upper side and a shaft part is formed on the lower side, is disposed to be liftable in a hollow housing having a bottom; a fixed seat having a passage is arranged above the valve part; a spring to press the pressure regulating valve toward the sheet and one O ring to provide sealing between the shaft part of the pressure regulating valve and the housing intervene in the housing; the housing is screwed into a housing accommodation chamber formed in the body of the regulator; and two O rings, positioned upward and downward, intervene between the housing and the body.

According to a third aspect of the invention, there is provided a regulator for fuel cell systems wherein a back pressure chamber and a pressure regulating chamber are partitioned from each other by a diaphragm and a pressure regulating valve is actuated by the shifting of the diaphragm to regulate the pressure in the pressure regulating chamber,

further comprising a valve mechanism,

wherein the valve mechanism is provided with a housing accommodation chamber, whose lower end is open, formed in the body of the regulator; a hollow housing having a bottom screwed into the housing accommodation chamber; two O rings, positioned upward and downward, intervening between the housing and the body; a pressure regulating valve liftably accommodated in the housing and one O ring intervening between the pressure regulating valve and the housing; a spring pressing the pressure regulating valve upward; and a fixed seat having a passage arranged above the pressure regulating valve.

With the structure according to the first aspect of the invention, by setting the effective area ratio between the two diaphragms as desired, the pressure regulated by the pressure regulating valve can be readily set to a desired level differing from the pressure working on the back pressure chamber. And, by setting the effective area of the second diaphragm smaller than the effective area of the first diaphragm, pressure regulation can be accomplished at a higher level than the pressure on the back pressure chamber side. Or, by setting the effective area of the first diaphragm smaller than the effective area of the second diaphragm, pressure regulation can be accomplished at a lower level than the pressure on the back pressure chamber side.

Therefore, in a fuel cell system, by setting the effective area of the second diaphragm smaller than the effective area of the first diaphragm, even if there is a constraint that, though hydrogen gas to be supplied to the fuel cells has to be regulated to a high pressure, the air available for this pressure regulation can be supplied only at a limited low pressure below the pressure to be regulated, the hydrogen gas can still be regulated to the high pressure with this available low pressure.

Also in the foregoing, by supplying pressurized air to the back pressure chamber and pressurized hydrogen gas to the pressure regulating chamber via the pressure regulating valve, hydrogen gas can be regulated as described above.

Further as described above, since setting one effective area smaller enables the pertinent diaphragm to be formed in a smaller diameter, this can contribute to reducing the size of the regulator and its cost.

Also in the foregoing, where the pressure of hydrogen gas is regulated in a configuration in which the atmosphere chamber is disposed between the first and second diaphragms and the atmosphere chamber is open to the atmosphere, even if the diaphragms are broken and hydrogen gas leaks into the atmosphere chamber, that hydrogen gas is discharged into the atmosphere to ensure safety.

Further in the foregoing, by disposing a hydrogen gas detector on the flow path from the atmosphere chamber to the atmosphere, that hydrogen gas leakage can be detected as mentioned above to ensure safety.

The second aspect of the invention can provide the same advantages as those described above.

In the second aspect, further, the pressure regulating valve, in which the valve part is formed on the upper side and the shaft part is formed on the lower side, is disposed to be liftable in the hollow housing having a bottom; the fixed seat having a passage is arranged above the valve part; the spring to press the pressure regulating valve toward the sheet and the single O ring to provide sealing between the shaft part of the pressure regulating valve and the housing intervene in the housing; the housing is screwed into the housing accommodation chamber formed in the body of the regulator; and the two O rings, positioned upward and downward, intervene between the housing and the body. This configuration can contribute to reducing the size and cost of the valve mechanism having the pressure regulating chamber for pressure regulation as stated above, and coupled with the aforementioned size reduction of the diaphragms, makes it possible to reduce the overall size of the regulator and its cost.

Further according to the third aspect of the invention, even a regulator lacking the configuration described above is enabled to solve the problems of size and cost reduction, similarly to the above-described aspects of the invention, by serving to reduce the size and cost of the valve mechanism.

Other objects, features and advantages of the present invention will become more apparent from the detailed description of the preferred embodiment thereof when taken in conjunction with the accompanying drawings.

### BRIEF DESCRIPTION OF THE DRAWINGS

FIG. 1 shows a vertical sectional view of a preferred embodiment according to the invention.

FIG. 2 shows an enlarged vertical sectional view of the valve mechanism part in FIG. 1.

FIG. 3 shows a schematic vertical sectional view of a conventional regulator.

FIG. 4 is a characteristic diagram showing the relationship between the pressure applied to the back pressure chamber and the regulated pressure in the regulator according to the invention and the conventional regulator.

FIG. 5 shows a partial sectional view of the valve mechanism in the conventional regulator.

### DESCRIPTION OF THE PREFERRED EMBODIMENT

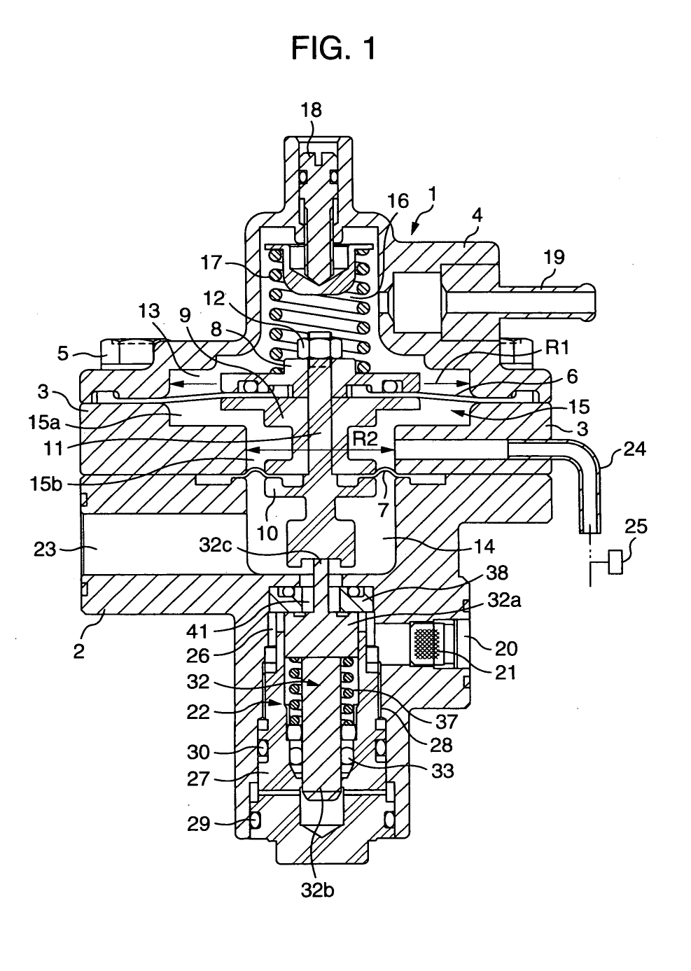

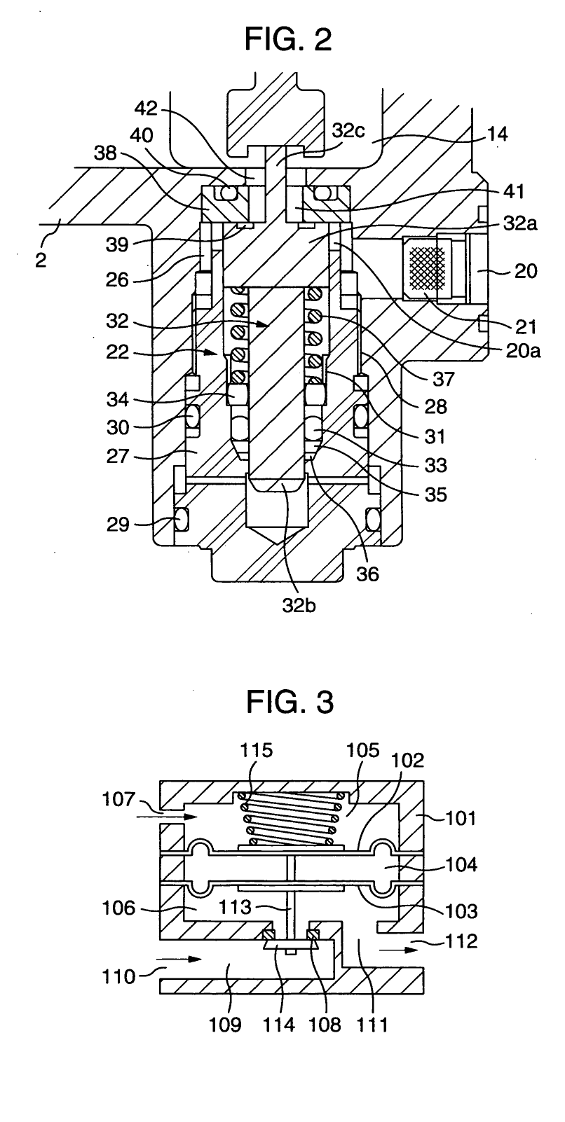

FIG. 1 shows a vertical sectional view of a regulator for fuel cell systems, which is a preferred embodiment of the invention.

Referring to FIG. 1, a regulator 1 has a lower body 2, an upper body 3 and a cover 4, and they are integrally linked with a bolt 5 and other elements.

Between the upper body 3 and the cover 4 arranged over this upper body 3, there is arranged a first diaphragm 6, which is the back pressure chamber side diaphragm, and the circumferential edge of the first diaphragm 6 is held between the upper body 3 and the cover 4.

Between the upper body 3 and the lower body 2 arranged underneath this upper body 3, there is arranged a second diaphragm 7, which is the pressure regulating chamber side diaphragm, and the circumferential edge of the second diaphragm 7 is held between the upper body 3 and the lower body 2. Therefore, the two diaphragms 6 and 7 constitute a double structure in which they face each other. Further, the diameter of the second diaphragm 7 is set smaller than that of the first diaphragm 6.

The central part of the first diaphragm 6 is held between a first plate 8 and a second plate 9; the central part of the second diaphragm 7 is held between the second plate 9 and a holder 10; and further the first plate 8 and the second plate 9 are held by a coupling shaft 11 formed integrally with the holder 10 and a nut 12.

A back pressure chamber 13 opening to the upper face of the first diaphragm 6 is disposed within the cover 4, while a pressure regulating chamber 14 opening to the under face of the second diaphragm 7 is provided within the lower body 2. Further the diameter of the back pressure chamber 13, i.e. the opening diameter R1 to the first diaphragm 6 and the diameter of the pressure regulating chamber 14, i.e. the opening diameter R2 to the second diaphragm 7 are set to be R1>R2, and the diameter of the back pressure chamber 13 is set to be equal to or greater than the diameter of the pressure regulating chamber 14.

An atmosphere chamber 15 is disposed in the central part of the upper body 3, penetrating it vertically. The atmosphere chamber 15 is formed by making the diameter of its upper compartment 15a opening to the first diaphragm 6 equal to the diameter of the back pressure chamber 13 and making the diameter of its lower compartment 15b opening to the second diaphragm 7 equal to the diameter of the pressure regulating chamber 14.

The setting of the diameter of the second diaphragm 7 to be smaller than the diameter of the first diaphragm 6 and the diameters of the pressure regulating chamber 14 and of the lower compartment 15b to be smaller than the diameters of the back pressure chamber 13 and of the upper compartment 15a makes the effective area (pressure receiving area) of the second diaphragm 7 smaller than the effective area (pressure receiving area) of the first diaphragm 6.

A spring chamber 16 is formed within the cover 4, and the spring chamber 16 communicates with the back pressure chamber 13. The spring chamber 16 is provided with a pressure regulating spring 17 to press the two diaphragms 6 and 7 downward, i.e. toward the pressure regulating chamber 14 with a prescribed load. The pressure of the pressure regulating spring 17 can be regulated with a regulating screw 18.

Further, a back pressure chamber inlet 19 for letting in pressurized air is disposed in the cover 4. The pressurized air let in through the back pressure chamber inlet 19 is guided to the back pressure chamber 13 via the spring chamber 16 and works on the upper face of the first diaphragm 6. The outer end side of the back pressure chamber inlet 19 is connected to piping from the generating source of the pressurized air, such as a compressor (not shown).

The lower body 2 is provided with a pressure regulating chamber inlet 20, and the outer end side of the pressure regulating chamber inlet 20 is connected to piping from a hydrogen tank (not shown). The pressure regulating chamber inlet 20 is equipped with a filter 21, whose downstream side (inner side) communicates with the pressure regulating chamber 14 via a passage 20a and a valve mechanism 22.

The lower body 2 is also provided with a pressure regulating chamber outlet 23, and the inner end side of the pressure regulating chamber outlet 23 communicates with the pressure regulating chamber 14 while its outer end side (not shown) is connected to piping on the anode side of the fuel cells.

The upper body 3 is provided with an atmosphere port 24, which communicates with the atmosphere chamber 15. The outer end side of the atmosphere port 24 is open to the atmosphere. To the atmosphere port 24 is connected a hydrogen gas detector 25 for detecting any hydrogen gas via a tube or the like, so that any hydrogen gas having leaked into the atmosphere chamber 15 in the event that the second diaphragm 7 is damaged can be discharged into the atmosphere through the atmosphere port 24 and the hydrogen gas passing that atmosphere port 24 can be detected by the hydrogen gas detector 25.

Next will be described the valve mechanism 22 mentioned earlier.

Underneath the pressure regulating chamber 14 in the lower body 2, there is formed a cylindrical housing accommodation chamber 26 whose lower end is open, and a hollow housing 27 having a bottom is inserted into the housing accommodation chamber 26 from that lower end and fastened with a screw 28. This constitution of the housing 27 having a bottom eliminates the need to block the lower end opening of the housing accommodation chamber 26 with another plug separate from the housing 27. Between the outer circumferential face of the housing 27 inserted as described above and the lower body 2, there intervenes a first O ring 29 consisting of an elastic material, positioned underneath the housing 27 in the axial direction, and also intervenes a second O ring 30 consisting of an elastic material, positioned substantially in the central part of the housing 27 in the axial direction.

The housing 27 is formed hollow and open on the upper side, and this hollow part constitutes a valve accommodation chamber 31, which is provided with a metallic pressure regulating valve 32 to be liftable. The pressure regulating valve 32 has a valve part 32a on the upper side and a shaft part 32b on the lower side. Between the lower portion of that shaft part 32b and the housing 27, there intervenes a third O ring 33 consisting of an elastic material, and a plate 34 intervenes between the shaft part 32b in the upper portion of the third O ring 33 and the housing 27. Further, between the under face of the third O ring 33 and the bottom face of the valve accommodation chamber 31, a first ring 35 and a second ring 36 intervene in a lapped state between the shaft part 32b and the housing 27.

The plate 34 is engaged with a stepped part formed in the housing 27 and its downward motion is thereby obstructed. A spring 37 is compressed by and intervenes between the plate 34 and the valve part 32a of the pressure regulating valve 32, and a prescribed pressing force (load) of the spring 37 presses the pressure regulating valve 32 upward.

Above the pressure regulating valve 32 in the lower body 2, there is fixed a metallic seat 38, and the up and down motion of the pressure regulating valve 32 causes its valve part 32a to come into and out of contact with the lower face of the seat 38. Incidentally, a sealing member 39 made of an elastic material protrudes from the upper face of the valve part 32a, and contributes to sealing performance between the pressure regulating valve 32 and the seat 38 even if they are metallic and increased in strength. Additionally, a fourth O ring 40 intervenes between the seat 38 and the lower body 2.

The seat 38 is formed in an annular shape, and has a passage 41 in its central part. In a part of the lower body 2 corresponding to the passage 41 is formed a passage 42, which establishes communication between the passage 41 and the pressure regulating chamber 14.

A rod 32c integrally protrudes from the upper face of the valve part 32a of the pressure regulating valve 32. As the rod 32c penetrates both passages 41 and 42, the rod 32c and the coupling shaft 11 are caused to move interlocked with each other by having its upper end come into contact or become coupled with the lower face of the coupling shaft 11.

Next will be described the operations which take place in the embodiment described above.

When pressurized air from a compressor or the like (not shown) is let into the back pressure chamber 13 through the back pressure chamber inlet 19, the downward pressing load working on the first diaphragm 6 is the product of the air pressure P1 applied to the first diaphragm 6 and the effective area (pressure receiving area) W1 of the first diaphragm 6, i.e. P1×W1.

The upward pressing load working on the second diaphragm 7 in a state in which the valve part 32a is opened and hydrogen gas supplied from the hydrogen tank flows from the pressure regulating chamber inlet 20 in the passage 41 and is let into the pressure regulating chamber 14 is the product of the air pressure P2 applied to the second diaphragm 7 and the effective area (pressure receiving area) W2 of the second diaphragm 7, i.e. P2×W2.

Therefore, the load at which the two diaphragms 6 and 7 become balanced is P1×W1=P2×W2.

In this embodiment of the invention, as the effective area (pressure receiving area) W1 of the second diaphragm 7 is set smaller than the effective area (pressure receiving area) W2 of the first diaphragm 6, when the two diaphragms 6 and 7 become balanced, the hydrogen gas pressure in the pressure regulating chamber 14 is greater than the air pressure in the back pressure chamber 13.

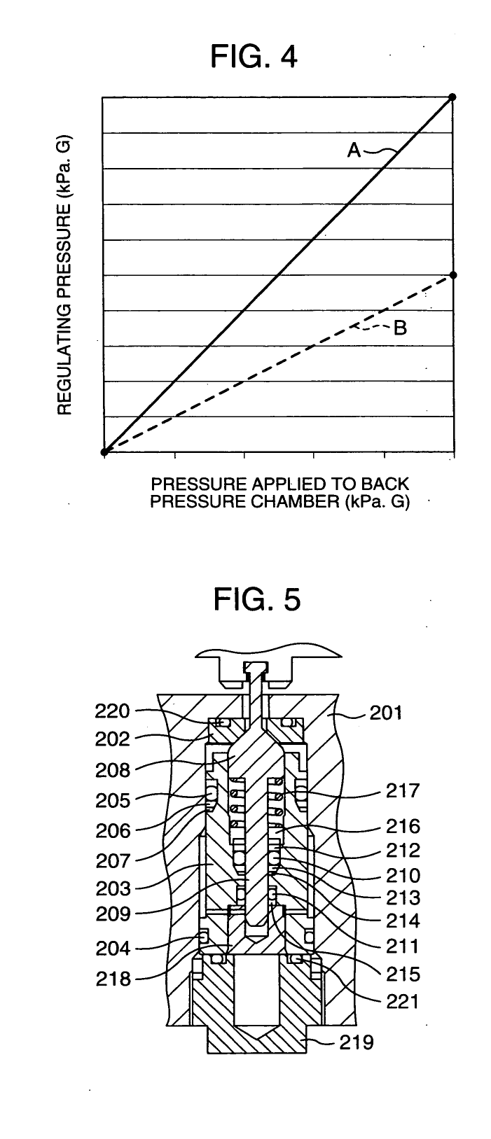

Thus, where the ratio between the effective area of the second diaphragm 7 on the pressure regulating chamber 14 side and the effective area of the first diaphragm 6 on the back pressure chamber side is 1:n, the regulating pressure that is obtained is n times the pressure applied to the back pressure chamber as indicated by characteristic A in FIG. 4.

If, for instance, the effective area (pressure receiving area) of the first diaphragm 6 is set to 4 mm², the effective area (pressure receiving area) of the second diaphragm 7 is set to 1 mm², and an air pressure of 50 kPa is let into the back pressure chamber 13, an equilibrium will be attained when the hydrogen gas pressure in the pressure regulating chamber 14 is 200 kPa.

Therefore, when the hydrogen gas pressure in the pressure regulating chamber 14 drops below 200 kPa, the two diaphragms 6 and 7 come down to cause the coupling shaft 11 to move the valve part 32a away from the seat 38, and high pressure hydrogen gas to be supplied to the pressure regulating chamber 14 through the pressure regulating chamber inlet 20 to raise the hydrogen gas pressure in the pressure regulating chamber 14. Further, when the hydrogen gas pressure in the pressure regulating chamber 14 rises in this way, the two diaphragms 6 and 7 move upward and, along with that, the valve part 32a also moves upward. When the hydrogen gas pressure in the pressure regulating chamber 14 reaches 200 kPa, the valve part 32a comes into contact with the seat 38 and is closed. This pressure regulating operation serves to keep the hydrogen gas pressure in the pressure regulating chamber 14 at 200 kPa, and the secondary pressure of hydrogen gas supplied from the pressure regulating chamber outlet 23 to the fuel cells is maintained at 200 kPa.

Incidentally, the aforementioned values of the effective areas of the two diaphragms 6 and 7, air pressures and hydrogen gas pressures are mere examples for the convenience of explanation, but their values are not limited to these and can be set as desired. Therefore, the effective area ratio between the first diaphragm 6 and the second diaphragm 7 can be set as desired, and the hydrogen pressures can be set as desired correspondingly to this effective area ratio.

The operations so far described make it possible in a fuel cell system, even if air pressure supplied into the back pressure chamber 13 is rather low, limited by the performance of the compressor generating this air pressure or any other factor, to regulate the pressure of hydrogen gas in the pressure regulating chamber 14 with that low air pressure in a higher pressure range than the air pressure and to supply that hydrogen gas of the higher pressure to the fuel cells. For instance, where any item that would entail a pressure loss is to be arranged on the hydrogen gas piping to the fuel cells as mentioned earlier, hydrogen gas of a higher pressure with an allowance for this pressure loss can be supplied.

The opening of the atmosphere chamber 15 between the two diaphragms 6 and 7 to the atmosphere through the atmosphere port 24 as in the above-described embodiment of the invention can prevent the destabilization of pressure regulation, which would result from thermal expansion and thermal contraction in a sealed air chamber as in the conventional structure described above. Thus, it is made possible to stabilize the loads mutually transmitted between the back pressure chamber 13 and the pressure regulating chamber 14.

Or, even if the two diaphragms 6 and 7 are broken and hydrogen and pressurized air leak into the atmosphere chamber 15, that hydrogen is discharged through the atmosphere port 24, and it is therefore made possible to prevent the hydrogen and pressurized air from combining with each other in the atmosphere chamber 15 and thereby inviting combustion reaction.

Also, by providing the hydrogen gas detector 25 to detect hydrogen flowing out of the atmosphere port 24, it is made possible to detect any hydrogen leak as in the aforementioned case, to establish a fail-safe function and, where the regulator is applied to a wheeled vehicle, to ensure its safety.

Further, the smaller diameter of the second diaphragm 7 on the pressure regulating chamber side than the diameter of the first diaphragm 6 on the back pressure chamber side as in this embodiment of the invention can contribute to reducing the size of this second diaphragm 7 and the space occupied by the pressure regulating chamber 14, making it possible to reduce the overall size of the regulator 1 and its cost.

Also, when hydrogen is to be supplied from the hydrogen tank to the fuel cells in a fuel cell system, the extremely high pressure of hydrogen in the hydrogen tank can be reduced at multiple stages including primary reduction and secondary reduction, and yet the hydrogen can be supplied at a prescribed high pressure to the fuel cells.

In this way, where the above-described regulator 1 according to the invention is used on piping for high pressure hydrogen gas reduced in pressure to a prescribed level, the pressure of the hydrogen supplied through the pressure regulating chamber inlet 20 is appropriately high, though made lower than the extremely high pressure of hydrogen in the hydrogen tank. Therefore, the air-tightness requirement of the valve mechanism 22 can be less strict than that of the regulator for primary pressure reduction arranged immediately downstream of the hydrogen tank.

In this connection, the embodiment of the invention is intended to reduce the number of components required and the size of the valve mechanism compared with the valve mechanism shown in FIG. 5, generally used for regulating very high gas pressures, and to reduce the overall size of the regulator and its cost besides taking advantage of the reduced size of the diaphragm 7 and the pressure regulating chamber 14 mentioned above.

Thus, the conventional configuration shown in FIG. 5 comprises a seat 202 disposed on a body 201, a housing 203 snapped onto the body 201, two O rings 204 and 205 and two O rings 206 and 207 intervening between the body 201 and the housing 203, a valve part 208 which is disposed in the housing 203 and comes into and out of contact with the seat 202, two O rings 210 and 211 and four rings 212 through 215 intervening between the shaft part 209 of the valve part 208 and the housing 203, a plate 216, a spring 217 pressing the valve part 208, two plugs 218 and 219 disposed in the lower part of the housing 203, an O ring 220 disposed on the seat 202, and an O ring 221 disposed on the plug 219.

As the valve mechanism 22 in the embodiment of the present invention is configured as earlier described unlike this conventional one, the four 0 rings 206, 207, 212 and 215 and the two O rings 211 and 221 in the conventional configuration shown in FIG. 5 are eliminated, and the housing 203 and the two plugs 218 and 219 are integrated to dispense with the two other plugs 218 and 219.

In this way, the embodiment of the invention is intended to be smaller in size and lower in cost than the conventional structure.

To add, this embodiment is a case in which the effective area of the second diaphragm 7 on the pressure regulating chamber 14 side is set smaller than the effective area of the first diaphragm 6 on the back pressure chamber 13 side and, even if the pressure from the back pressure source is rather low, the hydrogen gas pressure is regulated to an amplified level, higher than that back pressure. It is also possible, where the pressure from the back pressure source is high and the required regulated level of hydrogen gas is lower than that pressure from the back pressure source, to meet that requirement by setting the effective area (pressure receiving area) of the first diaphragm 6 on the back pressure chamber side than the effective area (pressure receiving area) of the second diaphragm 7 on the pressure regulating chamber side.

Thus, for instance, where the air pressure of the back pressure source is 200 kPa and the required regulated level of hydrogen gas is 50 kPa, the effective area of the first diaphragm 6 on the back pressure chamber can be set to 1 mm² and the effective area of the second diaphragm 7 on the pressure regulating chamber side to 4 mm².

Also, though the gas whose pressure is to be regulated is supposed to be hydrogen gas in the above-described embodiment, where the regulator is to be applied to fuel cells using some other fuel gas than hydrogen gas, that other fuel gas can be supplied to the pressure regulating chamber and regulated in pressure.

Furthermore, the regulator according to the invention can be applied as effectively as to an automotive fuel cell system for mounting on a motor vehicle as to a non-automotive fuel cell system.

1. A regulator for fuel cell systems having a first diaphragm on which a pressure on the back pressure chamber side works and a second diaphragm on which a pressure on the pressure regulating chamber side works, wherein a pressure regulating valve is actuated by the shifting of the two diaphragms depending on the relationship between said two pressures, and wherein the effective area of said first diaphragm and the effective area of said second diaphragm are differentiated.

2. The regulator for fuel cell systems, as stated in claim 1, wherein the effective area of said second diaphragm is set smaller than the effective area of said first diaphragm.

3. The regulator for fuel cell systems, as stated in claim 1, wherein the effective area of said first diaphragm is set smaller than the effective area of said second diaphragm.

4. The regulator for fuel cell systems, as stated in claim 1, wherein pressurized air is supplied to said back pressure chamber and pressurized hydrogen gas is supplied to the pressure regulating chamber via said pressure regulating valve.

5. The regulator for fuel cell systems, as stated in claim 2, wherein pressurized air is supplied to said back pressure chamber and pressurized hydrogen gas is supplied to the pressure regulating chamber via said pressure regulating valve.

6. The regulator for fuel cell systems, as stated in claim 3, wherein pressurized air is supplied to said back pressure chamber and pressurized hydrogen gas is supplied to the pressure regulating chamber via said pressure regulating valve.

7. The regulator for fuel cell systems, as stated in claim 1, wherein an atmosphere chamber is disposed between said first diaphragm and second diaphragm, and the atmosphere chamber is open to the atmosphere.

8. The regulator for fuel cell systems, as stated in claim 2, wherein an atmosphere chamber is disposed between said first diaphragm and second diaphragm, and the atmosphere chamber is open to the atmosphere.

9. The regulator for fuel cell systems, as stated in claim 3, wherein an atmosphere chamber is disposed between said first diaphragm and second diaphragm, and the atmosphere chamber is open to the atmosphere.

10. The regulator for fuel cell systems, as stated in claim 4, wherein an atmosphere chamber is disposed between said first diaphragm and second diaphragm, and the atmosphere chamber is open to the atmosphere.

11. The regulator for fuel cell systems, as stated in claim 5, wherein an atmosphere chamber is disposed between said first diaphragm and second diaphragm, and the atmosphere chamber is open to the atmosphere.

12. The regulator for fuel cell systems, as stated in claim 6, wherein an atmosphere chamber is disposed between said first diaphragm and second diaphragm, and the atmosphere chamber is open to the atmosphere.

13. The regulator for fuel cell systems, as stated in claim 7, wherein a hydrogen gas detector is disposed on the flow path of atmosphere from said atmosphere chamber.

14. The regulator for fuel cell systems, as stated in claim 8, wherein a hydrogen gas detector is disposed on the flow path of atmosphere from said atmosphere chamber.

15. The regulator for fuel cell systems, as stated in claim 9, wherein a hydrogen gas detector is disposed on the flow path of atmosphere from said atmosphere chamber.

16. The regulator for fuel cell systems, as stated in claim 10, wherein a hydrogen gas detector is disposed on the flow path of atmosphere from said atmosphere chamber.

17. The regulator for fuel cell systems, as stated in claim 11, wherein a hydrogen gas detector is disposed on the flow path of atmosphere from said atmosphere chamber.

18. The regulator for fuel cell systems, as stated in claim 12, wherein a hydrogen gas detector is disposed on the flow path of atmosphere from said atmosphere chamber.

19. A regulator for fuel cell systems having a back pressure chamber, a first diaphragm which receives a pressure from the back pressure chamber, a passage for supplying pressurized hydrogen gas to a pressure regulating chamber, a pressure regulating valve disposed on the passage, a second diaphragm which receives a pressure from said pressure regulating chamber, an atmosphere chamber disposed between the second diaphragm and said first diaphragm, and a coupling shaft which couples said two diaphragms and connects them to said pressure regulating valve, wherein the effective area of said second diaphragm is set smaller than the effective area of said first diaphragm, and pressure regulation is accomplished by opening and closing said pressure regulating valve at a higher pressure than the air pressure of the back pressure chamber.

20. The regulator for fuel cell systems, as stated in claim 19, wherein said pressure regulating valve, in which a valve part is formed on the upper side and a shaft part is formed on the lower side, is disposed to be liftable in a hollow housing having a bottom; a fixed seat having a passage is arranged above the valve part; a spring to press said pressure regulating valve toward the sheet and one O ring to provide sealing between the shaft part of the pressure regulating valve and the housing intervene in the housing; said housing is screwed into a housing accommodation chamber formed in the body of the regulator; and two O rings, positioned upward and downward, intervene between the housing and the body.

21. A regulator for fuel cell systems in which a back pressure chamber and a pressure regulating chamber are partitioned from each other by a diaphragm and a pressure regulating valve is actuated by the shifting of the diaphragm to regulate the pressure in the pressure regulating chamber, further said regulator comprising a valve mechanism,
wherein said valve mechanism is provided with a housing accommodation chamber, whose lower end is open, formed in the body of the regulator; a hollow housing having a bottom screwed into the housing accommodation chamber; two O rings, positioned upward and downward, intervening between the housing and the body; a pressure regulating valve liftably accommodated in the housing and one O ring intervening between the pressure regulating valve and the housing; a spring pressing the pressure regulating valve upward; and a fixed seat having a passage which is arranged above the pressure regulating valve.
